(19) United States
(12) Patent Application Publication
(10) Pub. No.: US 2014/0220170 A1
(43) Pub. Date: Aug. 7, 2014

(54) DEVICE FOR MAKING PATTIES OF COMPRESSIBLE FOOD MATTER

(71) Applicant: LES PROMOTIONS ATLANTIQUES INC / ATLANTIC PROMOTIONS INC., Longueuil (CA)

(72) Inventor: Nicolas BOURBEAU, Lachine (CA)

(73) Assignee: LES PROMOTIONS ATLANTIQUES INC / ATLANTIC PROMOTIONS INC., Longueuil (CA)

(21) Appl. No.: 13/757,151

(22) Filed: Feb. 1, 2013

(51) Int. Cl. A22C 7/00

(52) U.S. Cl. CPC A22C 7/0076
USPC 425/318

(57) ABSTRACT

A device for making patties of compressible food matter of different sizes, for example meat patties, comprises a first member having a first compression plate for making a patty of a corresponding size and shape. The device further comprises a second member to be added onto the first member. The second member has a second compression plate to extend from the first compression plate to form therewith a larger compression plate when the first member is mounted onto the second member, in order to make a food patty of a corresponding larger size. The first and second members have respective cooperating attaching means to connect the members in an assembled position.

### FIELD OF THE INVENTION

The present invention relates to a food preparation device, and more particularly to a device for making patties of compressible food matter, such as meat patties for example, as well as to a kit for assembling the same.

### BACKGROUND OF THE INVENTION

Known in the art are kitchen devices for making patties, such as meat patties. Namely, known to the Applicant are U.S. Pat. No. 1,297,900 (PATTON); U.S. Pat. No. 2,008,725 (PARKER); U.S. Pat. No. 2,553,880 (STIGLER); U.S. Pat. No. 2,584,536 (BELT); U.S. Pat. No. 2,631,331 (BABBITT); U.S. Pat. No. 3,679,167 (JUPITER et al.); U.S. Pat. No. 3,697,036 (KANBAR et al.); U.S. Pat. No. 3,837,775 (BOUCHER); U.S. Pat. No. 3,863,020 (ROBINSON); U.S. Pat. No. 3,909,881 (ANDERSON); U.S. Pat. No. 3,943,602 (SICLARI); U.S. Pat. No. 4,106,162 (FOURNIER); U.S. Pat. No. 4,765,029 (ROGAN); U.S. Pat. No. 5,007,819 (ANDERSON); U.S. Pat. No. 5,417,149 (RAIO et al.); U.S. Pat. No. 6,386,854 B1 (GUSS); and U.S. Pat. No. 6,997,697 B2 (BALKOS et al.). Also known to the Applicant are US patent applications having publication Nos: US 2001/0031302 A1 (BALKOS et al.); US 2006/0006581 A1 (ST. GERMAIN et al.); US 2008/0282477 A1 (CRAVATT); US 2010/0107900 A1 (HANSON); and US 2010/0239735 A1 (ROBBINS). Also known to the Applicant are US design patents Nos: US Des. 350,882 (CHARLAND); US D364,992 (WOODERSON et al.); US Des. 401,482 (DE ARE); US Des. 415,396 (LOUGHEAD et al.); and US D610,869 S (POUROUNIDIS et al.). Moreover, Spanish patent application No. ES 2 004 920 (BOSCH PUIG) and international PCT patent application having publication No. WO 2009/121052 A2 (HAUSER) are also known to the Applicant.

However, the teachings of the aforementioned documents suffer from drawbacks, as will be apparent in view of the following explanations.

Indeed, most of the known devices are configured to make patties of a fixed predetermined shape and size. Some of the known devices are configured for making patties of varying thicknesses, however the transveral shape and/or size, for example the diameter, of the patties can not be changed with theses devices because the compression surface is fixed. Other systems have been devised for making patties of varying shapes and sizes of the compression surface, usually involving interchangeable molds, where a first mold must first be disassembled from a main operational component and a second replacement mold must then be mounted onto the main operational component as a replacement to the first mold.

Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related devices known in the prior art.

In accordance with the present invention, the above mentioned object is achieved, as will be easily understood, by a device for making patties of compressible food matter such as the one briefly described herein and such as the one exemplified in the accompanying drawings.

According to the present invention, there is provided a device for making patties of compressible food matter, comprising: a first member comprising a first compression plate having an upper side provided with a handle and an opposite lower side having a first surface for compressing the compressible food matter into first patties; a second member comprising a second compression plate having a surface juxtaposable adjacent the first surface, the second surface extending from the first surface when the first and second members are assembled in an assembled position, to provide an extended surface for compressing the compressible food matter into second patties larger than the first patties, the first and second members having respective cooperating attaching means to connect said members in said assembled position.

Preferably, according to another aspect of the present invention, there is provided a kit for making patties of compressible food matter comprising the above-mentioned device, the kit further comprising: a first cylindrical element for guiding the first member and containing said compressible food matter while said compressible food matter is compressed into said first patties; and a second cylindrical element for guiding the first and second members when in said assembled position and for containing said compressible food matter while said compressible food matter is compressed into said second patties.

Advantageously, the same first member serves to make patties of different sizes. Indeed, for making smaller patties the device is used without the second member, and for making larger patties, the second member is easily and conveniently mounted on the first member in order to extend the compression surface of the first member.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a device for making patties of compressible food matter, according to an embodiment of the present invention, the device having a first member and a second member shown in an assembled position.

FIG. 2 is a bottom perspective view of the device of FIG. 1, shown in an unassembled position.

FIG. 3 is a perspective view of the device of FIG. 1, shown with the first member disengaged from the second member.

FIG. 4 is a perspective view of the device of FIG. 1, shown with the first member partially engaged with the second member.

FIG. 5 is an exploded view of a kit comprising the device of FIG. 1, according to an embodiment of the present invention.

FIG. 6 is a perspective view of the kit of FIG. 5, shown in an encased configuration.

FIG. 7 is a top plan view of the kit shown in FIG. 6.

FIG. 8 is a cross-sectional view of the kit shown in FIG. 7, taken along line 8-8.

FIG. 9 is a perspective view of components of the kit shown in FIG. 5.

FIG. 10 is a perspective view of other components of the kit shown in FIG. 5.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

Although the preferred embodiment of the present invention as illustrated in the accompanying drawings comprises components such as a disk plate, a ring plate, tabs, guides, etc., and although the preferred embodiment of the device, the kit and corresponding parts thereof consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the device according to the present invention, as will be briefly explained herein and as can be easily inferred herefrom, by a person skilled in the art, without departing from the scope of the invention.

Broadly described, the device for making patties of compressible food matter according to the present invention, as exemplified in the accompanying drawings, is an assembly comprising a pressing plate for making a food patty of a corresponding size and shape, for example a meat patty, and an add-on component to extend from the pressing plate to form therewith a larger pressing plate, in order to make a food patty of a corresponding larger size.

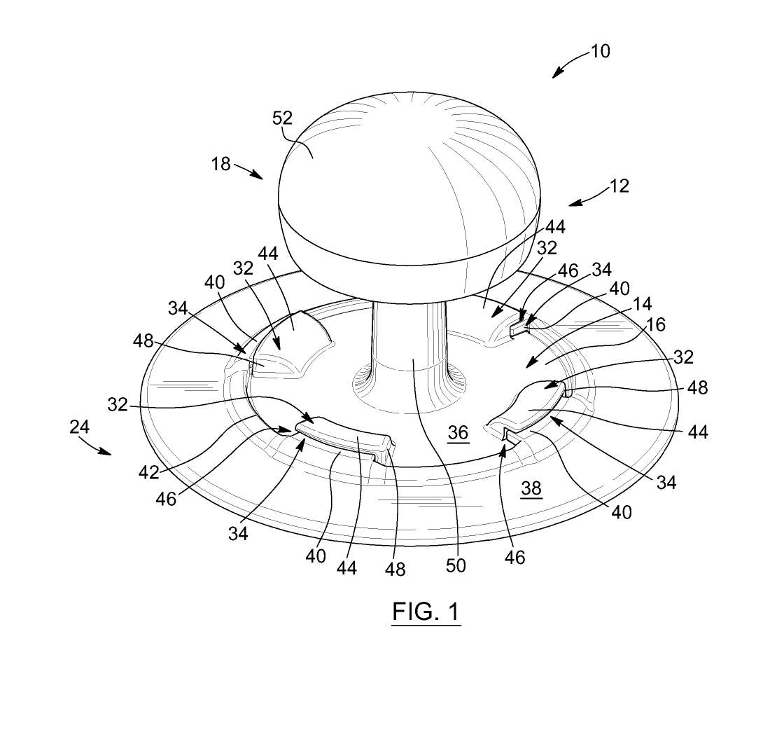

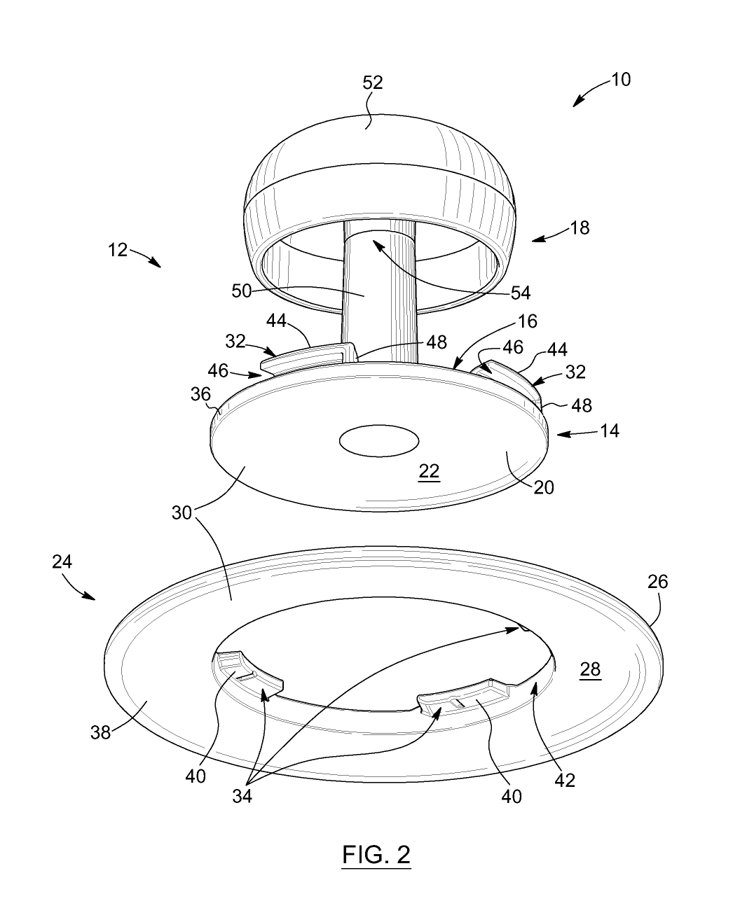

Preferably and as better illustrated in FIGS. 1 and 2, the device (10) of the present invention according to a preferred embodiment comprises a first member (12) comprising a first compression plate (14) having an upper side (16) provided with a handle (18) and an opposite lower side (20) having a first surface (22) for compressing the compressible food matter into first patties; a second member (24) comprising a second compression plate (26) having a second surface (28) juxtaposable adjacent the first surface (22), the second surface (28) extending from the first surface (22) when the first and second members (12, 24) are assembled in an assembled position, to provide an extended surface (30) for compressing the compressible food matter into second patties larger than the first patties, the first and second members (12, 24) having respective cooperating attaching means (32, 34) to connect said members (12, 24) in said assembled position, as can be easily understood by a person skilled in the art when referring to the accompanying drawings.

As apparent in the drawings the second compression plate (26) is shaped and sized to surround the first compression plate (14). Namely, the first compression plate (14) is a disk plate (36) and the second compression plate (26) is a ring plate (38).

According to alternative embodiments, the first and second compression plates may have any suitable shape. Furthermore, when the first and second member are in the assembled position, the second compression plate may extend from a portion of its periphery in any direction about the first compression plate.

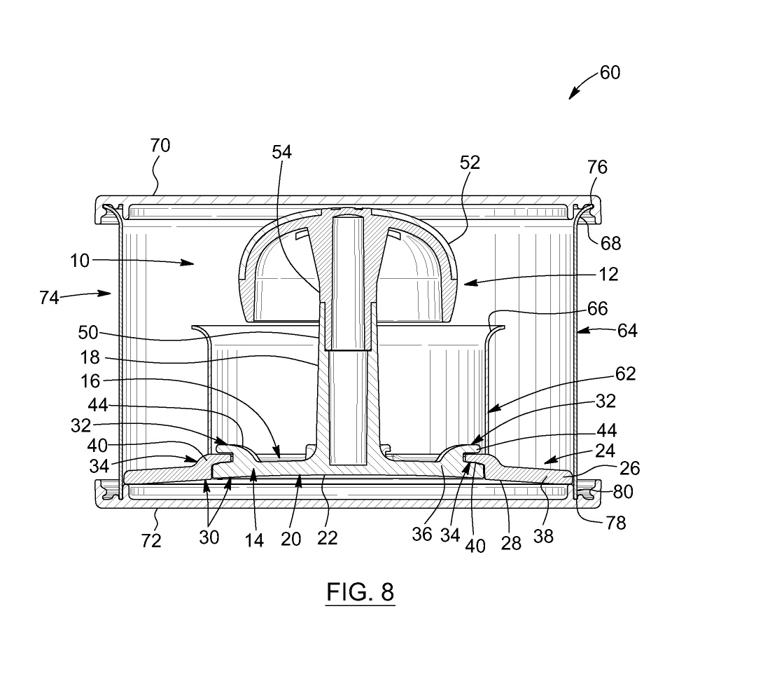

Referring back to FIGS. 1 and 2, and with further reference to FIG. 8, the first surface (22) and the second surface (28), each extends substantially flat with a slightly curved profile, as can be better seen in FIG. 8. Moreover, when the first and second members (12, 24) are in the assembled position, the extended surface (30) extends substantially continuously, along this slightly curved profile.

Alternatively, the first and second surfaces may each have any suitable profile for compressing the food matter into patties. For example, the first and second surfaces may form a planar extended surface. As another example, the first and/or second surfaces may be profiled with varying depths to compress the food matter to have a corresponding surface of varying levels. Furthermore, the upper surface of each of the first and second compression plates may have any suitable profile, as can be understood by a person skilled in the art.

Referring back to FIGS. 1 and 2, the mounting means (32, 34) of each of the first and second members (12, 24) are provided on an upper portion of the first and second compression plates, i.e. away from the first and second compression surfaces (22, 28), in order to avoid interfering with the profile of the first and second compression surfaces (22, 28).

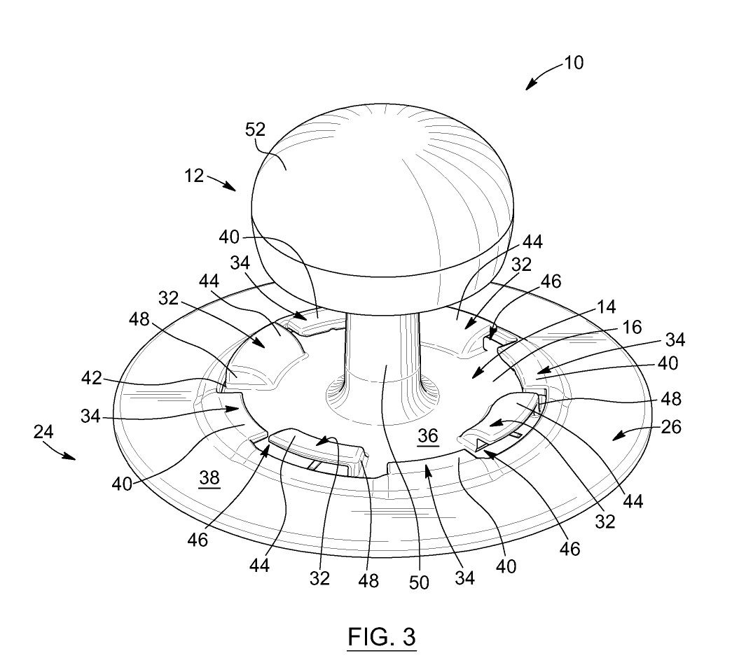

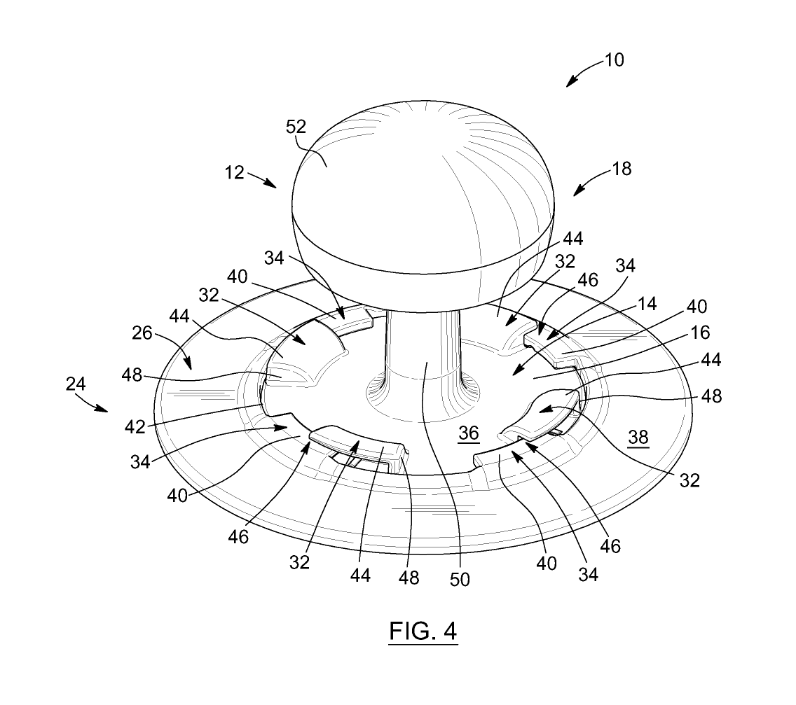

As better illustrated in FIGS. 3 and 4, the attaching means (34) of the second member (24) comprises four tabs (40), each tab extending inwardly along a segment of an inner edge (42) of the ring plate (38) and the attaching means (32) of the first member (12) comprises four guides (44), each guide extending along a segment of an outer edge (46) of the disk plate (36) for engaging with a corresponding one of the tabs (40) of the ring plate (38). The tabs (40) are spaces evenly about the inner edge (42) of the ring plates (38). The guides (44) are located and sized and oriented to cooperate with the tabs (40). More particularly, each guide (44) extends above the upper surface (16) of the first compression plate (14) leaving a space therebetween in order to receive a corresponding tab (40) of the second member (24). Each guide (44) has an open end (46) for receiving the corresponding tab (40) via a rotation of the ring plate (38) about the disk plate (36), each guide (44) further having a stopper end (48) for stopping the tab (40) into a locked position, in order to position the first and second members into the assembled position, better shown in FIG. 1.

In order to assemble the first and second members into the assembled position, the ring plate (38) is mounted onto the disk plate (36). More particularly, the ring plate (38) is place about the disk plate (36), positioning the tabs (44) between respective pairs of guides (44), as better shown in FIG. 3. The ring plate (38) is then rotated transversely with respect to the disk plate (36), thereby introducing the tabs in the respective spaces defined between the guides (44) and the upper surface (16) of the disk plate (36), as better shown in FIG. 3, where the tabs (40) are partially engaged with the guides (44). The ring plate (38) is further rotated until each tab meets the stopper end (48) of the corresponding guide (44), as better shown in FIG. 1. FIG. 2 shows the first and second members (12, 24) in an unassembled position.

As can be seen in the drawings, the handle (18) comprises a stem (50) extending from the upper side (16) of the first compression plate (14) and a head (52) at an upper end (54) of the stem (50). The head (52) is dome-shaped to facilitate operating the device.

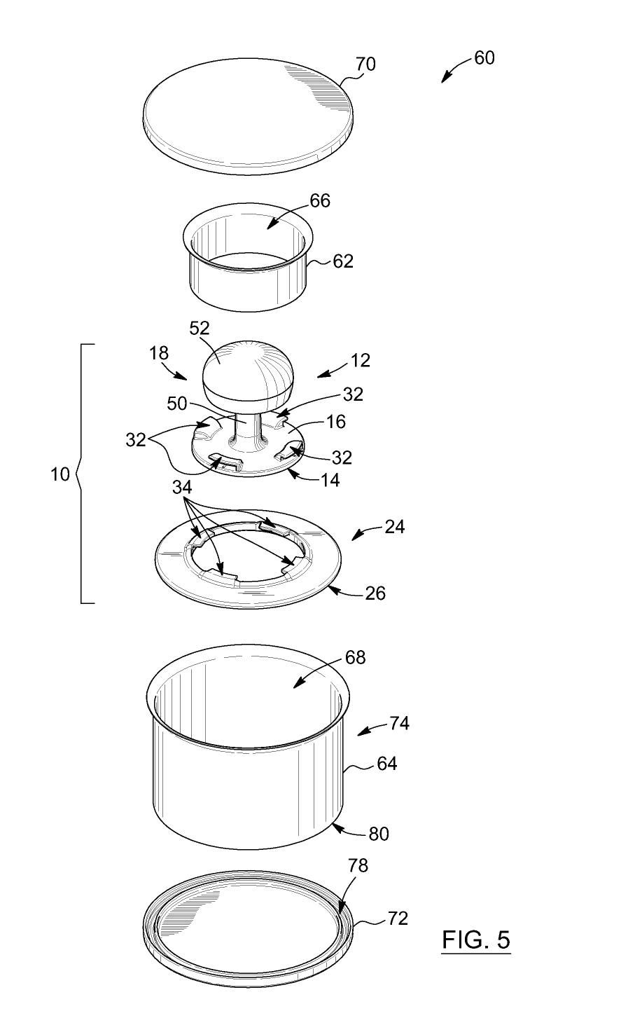

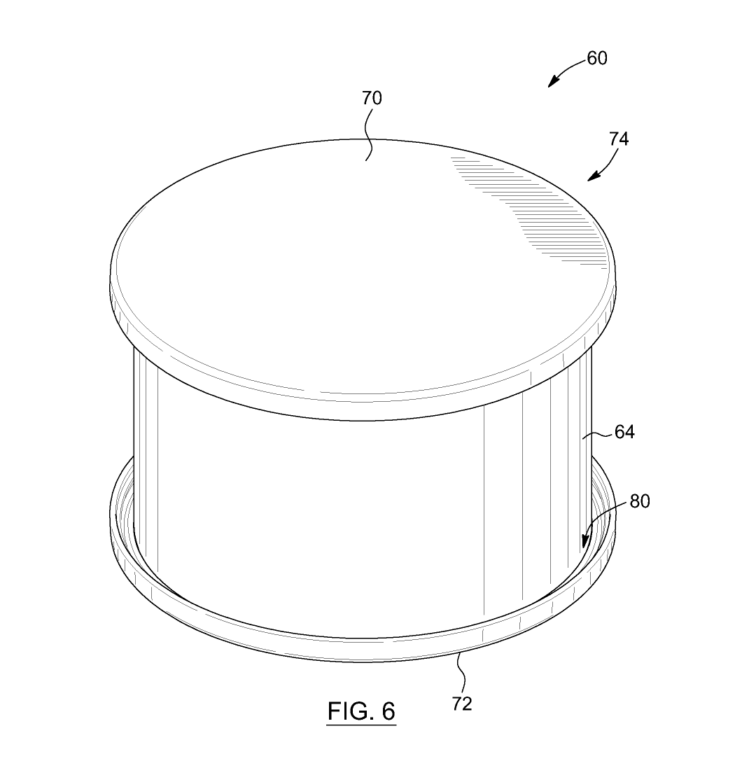

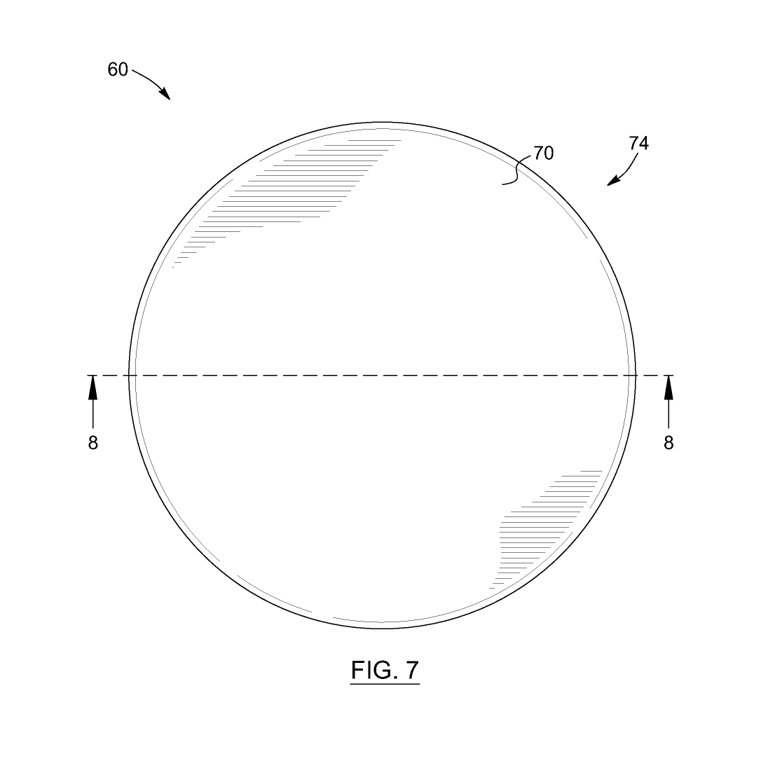

Referring now to FIGS. 5 to 8, there is shown a kit (60) for making patties of compressible food matter, according to an embodiment of the present invention. In FIG. 5, the components of the kit are shown in an exploded perspective view. In FIGS. 6 to 8, the components of the kit are shown in a nested configuration.

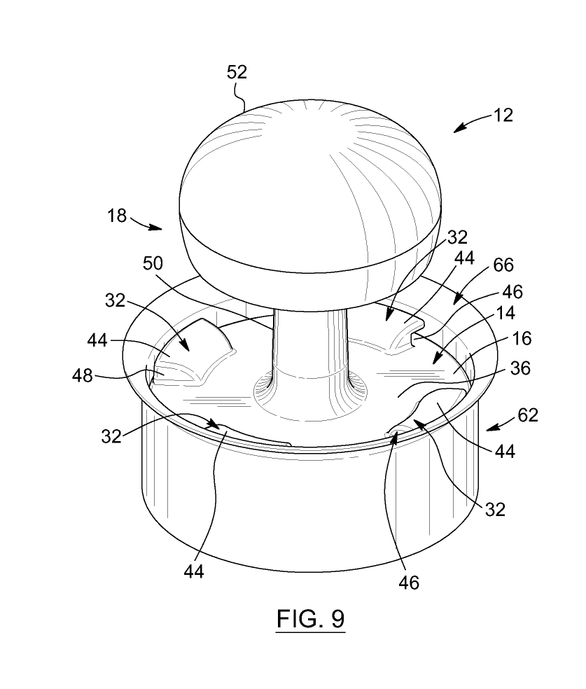

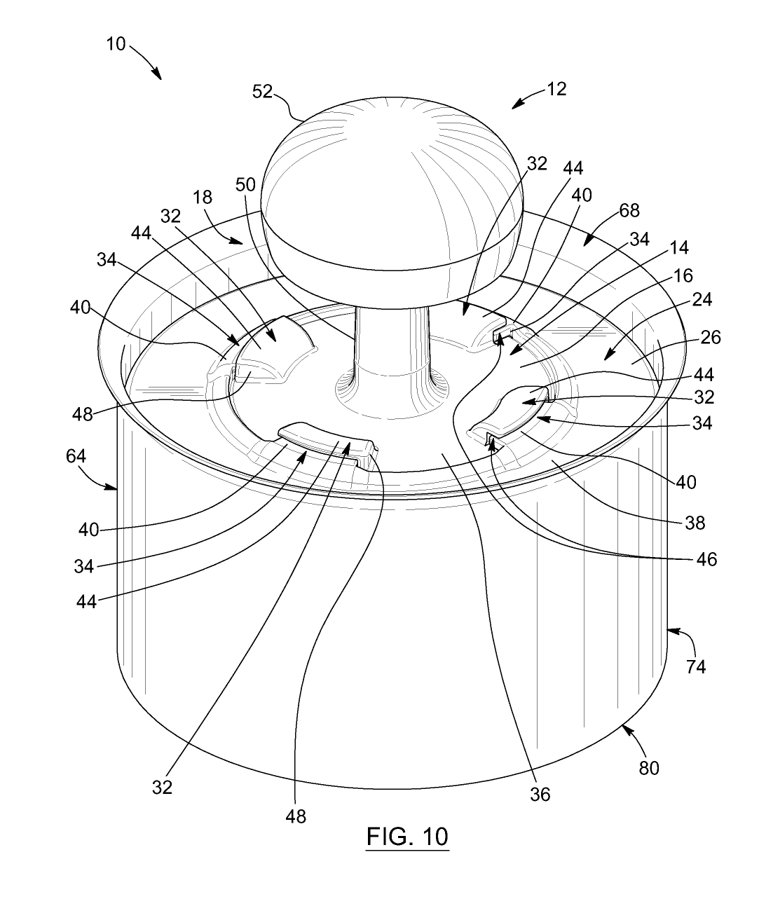

As can be seen, with further reference to FIGS. 9 and 10, the kit (60) comprises the above described device (10), including the first and second members (12, 24). The kit (60) further comprises a first cylindrical element (62) for guiding the first member (12) and containing the compressible food matter while the compressible food matter is compressed into said first patties, as better illustrated in FIG. 9. The kit (60) further comprises a second cylindrical element (64) for guiding the first and second members (12, 24) when in the assembled position (as shown in FIG. 1) and for containing said compressible food matter while said compressible food matter is compressed into said second patties, as better illustrated in FIG. 10. The first and second cylindrical elements (62, 64) each have a flared open end (66, 68).

As better illustrated in FIG. 8, the first cylindrical element (62) is sized and shape to fit within the second cylindrical element (64) when said first and second members (12, 24) are in the assembled position, and wherein the first member (12) is sized and shaped to fit through the first cylindrical element (62), in order to nest the first cylindrical element (62) about the handle (18) of the first member (12) and to nest the device (10) in the assembled position within the second cylindrical element (64). More particularly, the head (52) has a diameter no greater than the diameter of the disk plate (36).

The kit (60) further comprises a pair of covers (70, 72) for covering opposing ends of the second cylindrical element (64), to enclose the first and second members (12, 24) and the first cylindrical element (62) within a casing (74) formed by the second cylindrical element (64) and the pair of covers (70, 72). The covers each have grooves (76, 78) to cooperate with the open ends (68, 80) of the second cylindrical element (64) to enclose the casing (74), as better shown in FIG. 8.

The above-described device may be used for making meat patties from ground meat, or patties of other suitable food matter such as pastry dough, cheese, and/or mixture, and/or compounds thereof.

Several modifications could be made to the above-described device and/or kit for making patties of compressible food matter, without departing from the scope of the present invention, as can be easily understood by a person skilled in the art. Indeed and for example, the first cylindrical element of the kit may be replaced by a form having any suitable shape to cooperate with the first compression plate. Similarly, the second cylindrical element may be replaced by a form having any suitable shape to cooperate with the second compression plate. Furthermore, the attaching means, may be provided by any suitable mechanism for attaching or assembling the first and second members in an assembled position where the first and second surface form a substantially continuous compression extended surface.

Numerous other modifications could be made to the above-described embodiments. Indeed, the above-described embodiments are considered in all respect only as illustrative and not restrictive, and the present application is intended to cover any adaptations or variations thereof, as apparent to a person skilled in the art. Thus, the scope of the claims should not be limited by the preferred embodiments set forth in the examples, but should be given the broadest interpretation consistent with the description as a whole.

1. A device for making patties of compressible food matter, comprising:
a first member comprising a first compression plate having an upper side provided with a handle and an opposite lower side having a first surface for compressing the compressible food matter into first patties; and
a second member comprising a second compression plate having a second surface juxtaposable adjacent the first surface, the second surface extending from the first
surface when the first and second members are assembled in an assembled position, to provide an extended surface for compressing the compressible food matter into second patties larger than the first patties, the first and second members having respective cooperating attaching means to connect said members in said assembled position.

2. The device in accordance with claim 1, wherein the second compression plate is shaped and sized to surround the first compression plate.

3. The device in accordance with claim 2, wherein the first compression plate is a disk plate and the second compression plate is a ring plate.

4. The device in accordance with claim 3, wherein the attaching means of the second member comprises at least one tab, each tab extending inwardly along a segment of an inner edge of the ring plate and the attaching means of the first member comprises at least one guide, each guide extending along a segment of an outer edge of the disk plate for engaging with a corresponding one of the at least one tab of the ring plate.

5. The device in accordance with claim 4, wherein each guide has an open end for receiving the corresponding tab via a rotation of the ring plate about the disk plate, each guide further having a stopper end for stopping the tab into a locked position, in order to position the first and second members into the assembled position.

6. The device in accordance with claim 1, wherein the handle comprises a stem extending from the upper side of the first compression plate and a head at an upper end of the stem.

7. A kit for making patties of compressible food matter, comprising:
the device in accordance with claim 3;
a first cylindrical element for guiding the first member and containing said compressible food matter while said compressible food matter is compressed into said first patties; and
a second cylindrical element for guiding the first and second members when in said assembled position and for containing said compressible food matter while said compressible food matter is compressed into said second patties.

8. The kit in accordance with claim 7, the first and second cylindrical elements each have a flared open end.

9. The kit in accordance with claim 7, wherein the first cylindrical element is sized and shape to fit within the second cylindrical element when said first and second members are in the assembled position, and wherein the first member is sized and shaped to fit through the first cylindrical element, in order to nest the first cylindrical element about the handle of the first member and to nest the device in the assembled position within the second cylindrical element.

10. The kit in accordance with claim 9, further comprising a pair of covers for covering opposing ends of the second cylindrical element, to enclose the first and second members and the first cylindrical element within a casing formed by the second cylindrical element and the pair of covers.
